(19) United States
(12) Patent Application Publication
(10) Pub. No.: US 2016/0350696 A1
(43) Pub. Date: Dec. 1, 2016

(54) INTEGRATING DYNAMIC INTERPERSONAL RELATIONSHIPS IN AN ORGANIZATION HIERARCHY

(71) Applicant: International Business Machines Corporation, Armonk, NY (US)

(72) Inventors: John V. Delaney, Co.Meath (IE); Randy S. Johnson, O'Fallon, MO (US); Tedrick N. Northway, Wood River, IL (US); Clea A. Zolotow, Golden, CO (US)

(73) Assignee: International Business Machines Corporation, Armonk, NY (US)

(21) Appl. No.: 14/721,816

(22) Filed: May 26, 2015

(51) Int. Cl. G06Q 10/06; G06T 11/20; G06F 17/30

(52) U.S. Cl. CPC G06Q 10/063114; G06F 17/30604; G06T 11/206

(57) ABSTRACT

To determine resource utilization in an organization, a portion describing an interaction between a first participant and a second participant is identified in a human-readable content of a message. Using NLP, the portion is analyzed to extract a verb and a subject corresponding to the interaction. Using the verb, the first participant is characterized as a requestor of a participation related to the subject and the second participant is characterized as a requestee. A confidence value is assigned to a requestor-requestee relationship between the first participant and the second participant. A visual representation of an organization hierarchy is modified by adding a link between the identifiers of the requestor and the requestee, forming an integrated organization hierarchy. Using a set of visual links associated with the requestee in the integrated organization hierarchy, a utilization of the requestee is computed.

### TECHNICAL FIELD

The present invention relates generally to a method, system, and computer program product for representing organizational information. More particularly, the present invention relates to a method, system, and computer program product for integrating dynamic interpersonal relationships in an organization hierarchy.

### BACKGROUND

An organization is any entity that includes several people in a variety of roles. For example, a business entity, such as a software manufacturer, may include thousands of individuals performing a variety of tasks in a variety of roles. For example, some individuals may be programmers—an example role within the organization, some others may be managers—another example role within the organization, some may be administrators or executives—some other example roles, and so on.

A participant is a person functioning in some role within an organization. An organization uses some representation of the hierarchy of participants, often referred to as an “org chart” (hereinafter, “organization hierarchy”). Typically the organization hierarchy takes the form of a tree graph where the nodes represent roles, persons, or persons and roles. For example, an example organization hierarchy has a Chief Information Officer (CIO) role, name of a person who is the CIO, or both, at the root node. The root node has one or more children nodes representing roles or persons reporting to the CIO, such as one or more vice-president (VP) roles and/or persons. A VP node similarly has several manager nodes as child nodes, and a manager node has one or more team-lead child nodes, and so on, until all roles and/or persons are presented in the organization hierarchy.

An organization hierarchy represents how an organization is structured. In other words, the organization hierarchy represents a reporting hierarchy, a hierarchy of roles, a reporting and managing structure of personnel, and the like.

During the operations of an organization, people in the organization form teams to work on projects as various projects come about. The people who are involved in a project collaborate with each other to accomplish the tasks of the project or to share responsibilities for parts of the project. Often, when the project has been completed, the teams disband or disperse, and the people who participated in a team for the completed project become members of other teams for other projects.

Natural language processing (NLP) is a technique that facilitates exchange of information between humans and data processing systems. For example, one branch of NLP pertains to transforming human readable content into machine usable data. For example, NLP engines are presently usable to accept human readable input content such as a newspaper article or a whitepaper, and produce structured data, such as an outline of the input content, most significant and least significant parts, a subject, a reference, dependencies within the content, and the like, from the given content.

The input information for NLP can be sourced from any number of data sources. Generally, the input information can take any human-readable form and can include any type of content, including but not limited to text in a language, numerical data, conversational or unstructured information, structured data, and the like.

Presently available systems and methods for NLP-based information extraction construct “triples” of extracted information. A triple is an [ENTITY <VERB> ENTITY] construct, where one of the entities is a subject specified in the given corpus, and the subject entity performs an act (verb) specified in the corpus on an object entity specified in the given corpus. For example, given suitable corpus, a presently available system or method can create a triple such as [Barack Obama <president of> US].

Presently, the extracted triple artifacts can be stored, indexed, and made available for semantic processing of data and document retrieval. Existing frameworks such as Resource description Framework (RDF) and Web Ontology Language (OWL) are some examples of presently available methods for extracting such triples.

Social media comprises any medium, network, channel, or technology for facilitating communication between individuals and/or entities (users). Some common examples of social media are Facebook™ or Twitter™, each of which facilitates communications in a variety of forms between large numbers of users (Facebook is a trademark of Facebook, Inc. in the United States and in other countries. Twitter is a trademark of Twitter Inc. in the United States and in other countries.) Social media, such as Facebook or Twitter allow users to interact with one another individually, in a group, according to common interests, casually or in response to an event or occurrence, and generally for any reason or no reason at all.

Some other examples of social media are websites or data sources associated with radio stations, news channels, magazines, publications, blogs, and sources or disseminators of news or information. Some more examples of social media are websites or repositories associated with specific industries, interest groups, action groups, committees, organizations, teams, or other associations of users.

Data from social media comprises unidirectional messages, or bi-directional or broadcast communications in a variety of languages and forms. Such communications in the social media data can include proprietary conversational styles, slangs or acronyms, urban phrases in a given context, formalized writing or publication, and other structured or unstructured data.

### SUMMARY

The illustrative embodiments provide a method, system, and computer program product for integrating dynamic interpersonal relationships in an organization hierarchy. An embodiment includes a method for determining resource utilization in an organization. The embodiment identifies, in a human-readable content of a message, a portion describing an interaction between a first participant and a second participant. The embodiment analyzes, using a processor and a memory for Natural Language Processing (NLP), the portion to extract a verb and a subject corresponding to the interaction. The embodiment characterizes, using the verb, the first participant as a requestor of a participation related to the subject and the second participant as a requestee of the participation related to the subject. The embodiment assigns a first confidence value to a requestor-requestee relationship between the first participant and the second participant. The embodiment adds a relationship entry in a repository, the relationship entry comprising an identifier of the requestor, an identifier of the requestee, and the first confidence value. The embodiment modifies a visual representation of an organization hierarchy by adding, in the visual representation, a link between the identifier of the requestor and the identifier of the requestee, forming an integrated organization hierarchy. The embodiment computes, using a set of visual links associated with the requestee in the integrated organization hierarchy, a utilization of the requestee.

Another embodiment includes a computer program product for determining resource utilization in an organization, the computer program product comprising one or more computer-readable storage devices, and program instructions stored on at least one of the one or more storage devices.

Another embodiment includes a computer system for determining resource utilization in an organization, the computer system comprising one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example dynamic team participation that can be converted into an integrated organization hierarchy in accordance with an illustrative embodiment;

FIG. 4 depicts an abbreviated view of a traditional organization hierarchy that is utilized in a dynamic project or team operations;

FIG. 5 depicts a logical arrangement of responsibilities in a dynamic project or team in the organization in accordance with an illustrative embodiment;

FIG. 6 depicts an integrated organization hierarchy in accordance with an illustrative embodiment;

FIG. 7 depicts a flowchart of an example process for integrating dynamic interpersonal relationships in an organization hierarchy in accordance with an illustrative embodiment; and

FIG. 8 depicts a flowchart of an example process of integrating dynamic interpersonal relationships in an organization hierarchy in accordance with an illustrative embodiment.

### DETAILED DESCRIPTION

Participants of an organization communicate with each other when collaborating on various projects. A significant portion of such communications is in electronic form, such as by exchanging messages on social media, emails, instant messages, post on blogs or forums, and many other similarly purposed methods of electronic communications. Within the scope of the illustrative embodiments a data source is any source that can store and provide the data of one or more such electronic communications between participants of an organization.

The illustrative embodiments recognize that an organization hierarchy is a static representation of the roles and/or names of participants of the organization. For example, in a presently used organization hierarchy, a participant “John Doe” remains a programmer (role) under a team-lead (role or name), under a manager (role or name) regardless of the teams John Doe joins, and regardless of the projects in which John Doe participates.

The illustrative embodiments recognize that a presently available organization hierarchy does not reflect a participant's actual involvements with other participants as projects and teams are dynamically created with the passage of time. For example, the organization hierarchy is not revised every time a participant joins or leaves a team, is requested to participate in or contribute to a project, asks or is asked for an opinion, asks or is asked for a service or performance, and the like.

Furthermore, such participations can be relatively short lived as compared to the timeframe over which changes occur in an organization that are reflected in a change to an organization hierarchy. For example, a participant may be asked to provide a quick opinion on some aspect of a project, which may be a participation that lasts for a few minutes and a few exchanges of electronic communications. As another example, a participant may be asked to provide a service or data to a project, which may be a participation that lasts for a few days and results in several dozens of electronic communications. In contrast, a participant's role changes after several years, reporting structures in orgs change once or twice every few years. Thus, the illustrative embodiments recognize that an organization hierarchy is relatively static as compared to the speed or dynamicity of the operations and actions of the participants.

Furthermore, a participant can participate in more than one projects or teams at a given time. To get some information about the involvements of a participant, someone, such as a manager of the participant, has to look at a variety of project-specific resource allocation data, such as project plans. From such diversified project-specific resource allocation data, information about a participant's involvements have to be extracted, often manually and if at all available. Still, a participant's true level of participation in the organization is unclear because many participations—such as the quick opinion in an example above—are not tracked using project plans.

Thus, the illustrative embodiments recognize that a dynamic view of the involvements of the participants is needed in an organization. The presently used organization hierarchies suffer from several drawbacks, such as in the examples described above, and are therefore unsuitable for this purpose. A method and system is needed to determine the interactions, involvements, commitments, participations, task-based or project-based relationships with others, and the like, of various participants in a given organization.

The illustrative embodiments used to describe the invention generally address and solve the above-described problems and other problems related to modifying an organization hierarchy according to the dynamic relationships of the organization's participants. The illustrative embodiments provide a method, system, and computer program product for integrating dynamic interpersonal relationships in an organization hierarchy.

An embodiment collects information from a variety of data sources, data of electronic communications between various participants in a given organization. Usually, a data source that provides such data is within the organization's data network, e.g., owned and operated by the organization.

The embodiment selects an electronic communication (hereinafter, interchangeably referred to as a “message”) from the collected electronic communications. The message can include several portions, not all of which reveal the role or identity of a requestor participant who is requesting something—such as data, participation, collaboration, assistance, opinion, and the like—from a requestee participant. For example, an email may reveal a sender and a receiver, but the sender need not necessarily be the requestor, such as when the email is a reply from a requestee sender providing the requested item. The body of the email helps establish the context, establish who the requestor and the requestee are, and thereby a relationship between the requestor and the requestee.

The relationship between a requestor and a requestee is usually based on a verb. The requestor “asks” the requestee, using some verb that conveys the asking action in the message. Similarly, a requestee “provides” or “performs” a step in the providing, using some verb that conveys the performing action in the message. For example, a requestor may say, “John, can you find that document for the xyz product meeting tomorrow?”, or, “I am going to need you at the presentation.” The requestee may respond, “Jane, do you need the document right now?”, or “to which document are you referring?”.

As can be seen from these non-limiting examples, electronic communications between a requestor and a requestee include some verb that conveys an asking meaning and a providing meaning, thereby establishing a requestor-requestee relationship.

The embodiment identifies one or more portions of the message, which contain information of a form that is usable to identify such entity-verb relationships such that a requestor-requestee relationship can be established for the message. Different types of electronic communications are likely to have such portions in different places, and the embodiment is configured to find such portions in an evolving collection of the types of electronic communications in use. The embodiment can use NLP to identify such a portion in a given electronic communication.

From the NLP analysis of the portion, the embodiment identifies the participants in the message, the verb that relates the participants in a requestor-requestee relationship in the message, and a subject of the relationship (hereinafter referred to simply as “subject” unless expressly distinguished where used). A subject is the context in which the requestor-requestee relationship exists in the message. For example, the subject may be the document, data, opinion, service, or participation being requested, by the requestor, via the verb, to the requestee. This subject is distinct from the contents of the subject-line in an email or an equivalent structure or position in other types of electronic communications.

In some cases, the NLP analysis may also extract project information, such as when some portion of the message provides a project name or project code, to which the message pertains. For example, one sentence in the message may ask for an opinion, and another sentence in the message may discuss a though on a product. The sentences may be different portions of the message, and the NLP analysis may establish the product name as the project information.

In performing the NLP analysis, the embodiment assigns one or more confidence values to one or more pieces of the extracted information. For example, which participant is the requestor and which participant is the requestee in a message cannot always be established with one hundred percent certainty. That relationship depends on the context of the relationship, which may require analyzing additional information, such as additional messages between the participants. The confidence value assigned to the requestor and requestee identification expresses a level of reliability that the identified requestor is indeed the requestor and that the identified requestee is indeed the requestee.

Similarly, when the project information is extracted, the embodiment assigns a confidence value to the project information as well. This confidence value expresses a level of reliability that the identified project is indeed the project about which the requestor and the requestee identified from the message are related.

The embodiment saves the requestor-requestee relationships, the project information when available, and their respective confidence values as a relationship entry in a repository of relationship data.

The embodiment also determines a role or name that the requestor participant occupies in a given organization hierarchy. Similarly, the embodiment also determines a role or name that the requestee participant occupies in a given organization hierarchy.

The embodiment assigns another confidence value to the determined roles or names. This confidence value expresses a level of reliability that the identified roles or names are indeed the roles or names of the requestor and the requestee in the message are related.

This confidence value can differ, for example, when a particular participant occupies more than one roles in the organization hierarchy, or more than one participants with the same name are present in the organization hierarchy. When the embodiment finds several names or roles matching a requestor, a requestee, or both, and depending upon what other clues are available for NLP analysis in one or more electronic communications, this confidence value can be below a threshold value. When the embodiment finds a unique name or role matching a requestor, a requestee, or both, this confidence value can be at or above the threshold value.

The embodiment analyzes several electronic communications in this manner and creates several relationship entries. When several relationship entries contain the same or similar relationship, the embodiment concludes that the reliability of that relationship is above a different threshold value. Accordingly, for that relationship, the embodiment assigns an overall confidence value exceeding the threshold for overall confidence.

The embodiment combines the relationship entries and the various confidence values associated therewith, with the organization hierarchy to form an integrated organization hierarchy. Because the analysis of the electronic communications is ongoing in the organization as projects are formed and completed, and teams are formed and disbanded, the relationship entries are added, modified, and deleted from the repository dynamically. Accordingly, the embodiment combines the added entries with the organization hierarchy or a previously created integrated organization hierarchy, or modifies an integrated organization hierarchy using modified entries or deleted entries previously combined entries.

An integrated organization hierarchy shows all the contents of the original organization hierarchy on which it is based, but also shows the actual relationships existing between the participants of the organization in the dynamic environment of the organization.

The relationship between two participants depends upon the quality of the information available in the electronic communications. For example, in some cases, the embodiment can only establish with a greater-than-threshold confidence that two participants are related to one another in a basic requestor-requestee relationship, to wit, without any specific project information or role/name information.

In some cases, when project information is extracted from the electronic communications, the integrated organization hierarchy also shows the project specific information with the actual relationships. The relationship between two participants in such a case is a project-based relationship, which is more defined than a basic relationship.

In cases where role or name information is extracted from the electronic communications, the integrated organization hierarchy also uses the role/name information in visually depicting the actual relationships. The relationship between two participants in such a case is a role-based relationship, which is also more defined than a basic relationship. A relationship can be both project-based as well as role-based when sufficient information can be extracted from the available electronic communications.

The embodiment further characterizes a visually depicted actual relationship with one or more confidence values stored in the one or more relationship entries that form the basis for that actual relationship in the integrated organization hierarchy. For example, a color, a weight, a pattern, or some combination thereof, of a line linking two participants in an actual relationship in an integrated organization hierarchy can be adjusted or changed depending upon a confidence value associated with or found in a relationship entry that supports that actual relationship.

These creations and modifications of the integrated organization hierarchy now reflect the dynamic environment of the organization as opposed to the static reporting structure of a traditional organization hierarchy.

A method of an embodiment described herein, when implemented to execute on a device or data processing system, comprises substantial advancement of the functionality of that device or data processing system in depicting the dynamic involvements of the participants in an organization. For example, prior-art organization hierarchy is unable to change on the fly as projects are created and completed and as various participants join or leave teams in an organization's dynamic environment. The embodiments continuously and automatically monitor electronic communications between the participants in an org, and analyze them to identify new, changed, or no longer existing dynamic relationships between various participants regardless of the organization's reporting structure. Operating in a manner described herein, an embodiment presents an integrated organization hierarchy that provides a visual representation, such as via a modified graphical graph based on the underlying organization hierarchy. The integrated organization hierarchy of the illustrative embodiments enables a comprehensive and dynamic view of the involvements and commitments of the various participants in the organization. Such manner of constructing and presenting an organization hierarchy is unavailable in presently available devices or data processing systems. Thus, a substantial advancement of such devices or data processing systems by executing a method of an embodiment improves the utilization of human resources in an org, facilitates better coordination of projects in the org, and results in significant improvement in the operation and management of the organization as a whole.

The illustrative embodiments are described with respect to certain graphs, roles, electronic communication types, words or phrases, relationships, contexts, subjects, organization hierarchy, presentations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

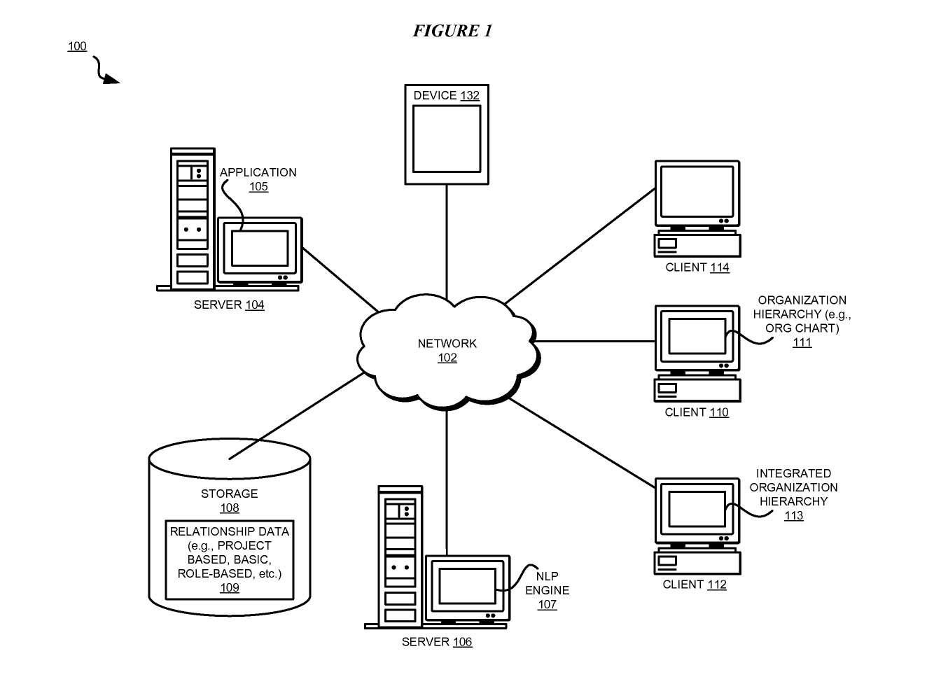

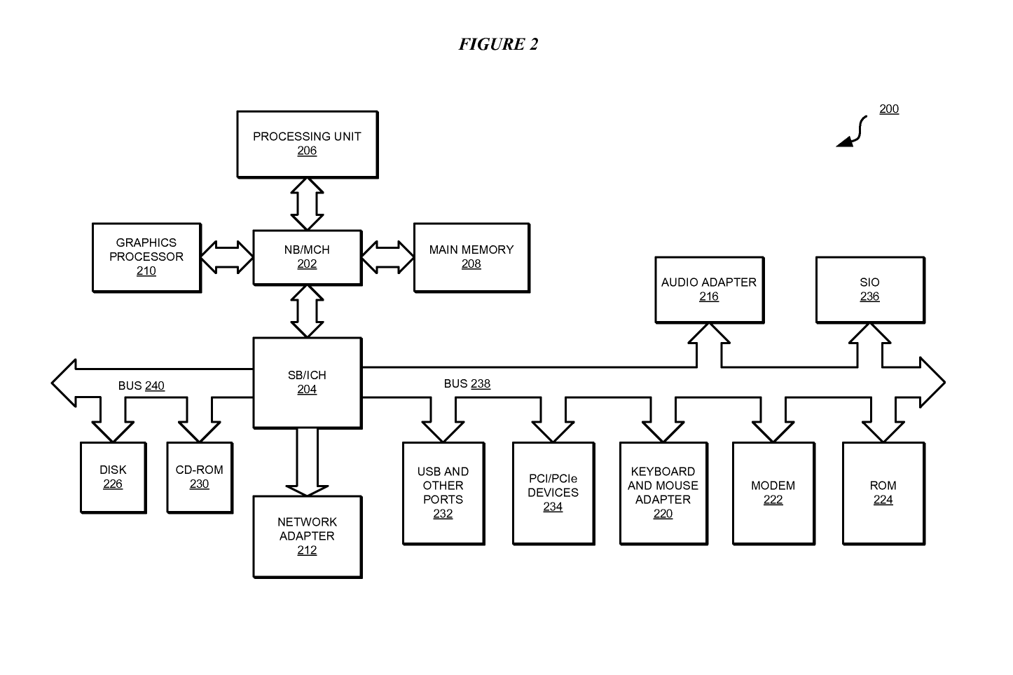

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner. Application 105 implements an embodiment described herein. Organization hierarchy 111 is a prior-art organization hierarchy as described herein. Application 105 uses NLP engine 107 to create relationship data 109. Relationship data 109 can include basic relationship entries, project-based relationship entries, role-based relationship entries, project and role based relationship entries, or some combination thereof. Application 105 uses relationship data 109 to produce integrated organization hierarchy 113.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

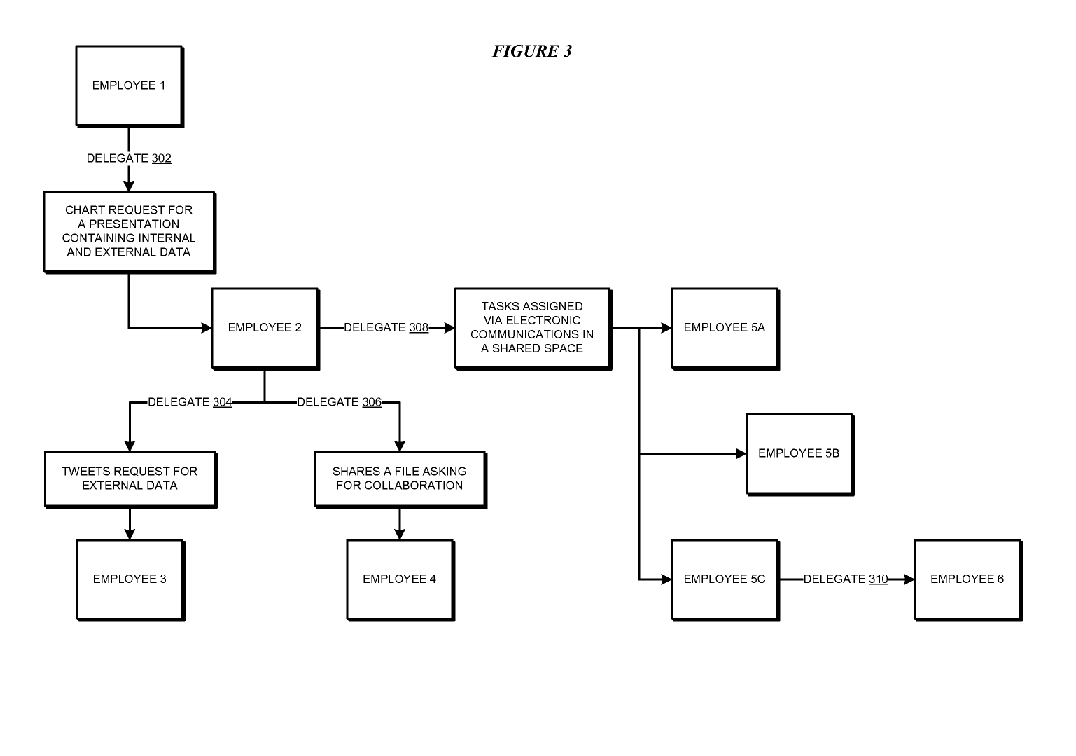

With reference to FIG. 3, this figure depicts a block diagram of an example dynamic team participation that can be converted into an integrated organization hierarchy in accordance with an illustrative embodiment.

Employees 1, 2, 3, 4, 5a, 5b, 5c, and 6 are employees in an organization that operates data processing environment 100 in FIG. 1. As an example, employees 1, 2, 3, 4, 5a, 5b, 5c, and 6 are represented in organization hierarchy 111 by role, name, or both. For the clarity of the description, the labels “Employee 1”, “Employee 2”, “Employee 3”, “Employee 4”, “Employee 5a”, “Employee 5b”, “Employee 5c”, and “Employee 6” are treated as names of the employees.

In the example project scenario depicted in this figure, employee 1 delegates (302) a responsibility to (i.e., asks) employee 2 in an electronic communication, e.g., by an instant message or email, requesting a chart for a presentation. Assume that the example chart comprises data that is external to the organization and data that is internal to the organization.

Employee 2 delegates (304) (i.e., asks) employee 3 in an electronic communication, e.g., by tweeting, requesting the external data chart for a presentation. Employee 2 delegates (306) (i.e., asks) employee 4 in an electronic communication, e.g., by sharing an internal file, requesting employee 4 to collaborate on the file.

Employee 2 delegates (308) (i.e., asks) employee 5a, employee 5b, and employee 5c, in an electronic communication, e.g., by posting a message in a shared space, requesting them to perform certain tasks. Employee 5c delegates (310) (i.e., asks) employee 6 in an electronic communication, e.g., by social media private message, requesting assistance in the presentation project.

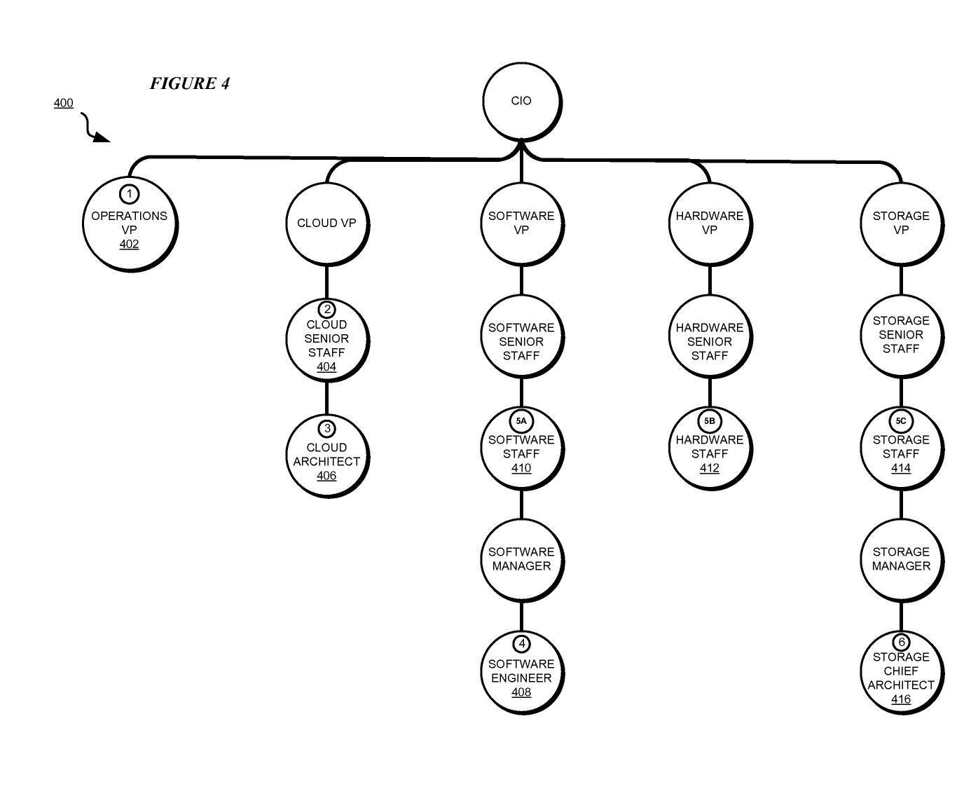

With reference to FIG. 4, this figure depicts an abbreviated view of a traditional organization hierarchy that is utilized in a dynamic project or team operations. Organization hierarchy 400 is an example of organization hierarchy 111 in FIG. 1.

Employee 1 occupies role 402 as “operations VP” under a CIO root node. Employee 2 is a deeper child node in another branch of organization hierarchy 400 and occupies role 404 as “cloud senior staff”. Employee 3 is a still deeper child node in the same branch as employee 2 but occupies role 406 as “cloud architect”.

Proceeding in this manner, it can be seen that employee 4 has role 408, employee 5a has role 410, employee 5b is in role 412, employee 5c is in role 414, and employee 6 has role 416 in different branches of organization hierarchy 400. As is also evident from this example, employees 1, 2, 3, 4, 5a, 5b, 5c, and 6 are situated in organization hierarchy 400 that does not show that they are collaborating in the manner of FIG. 3.

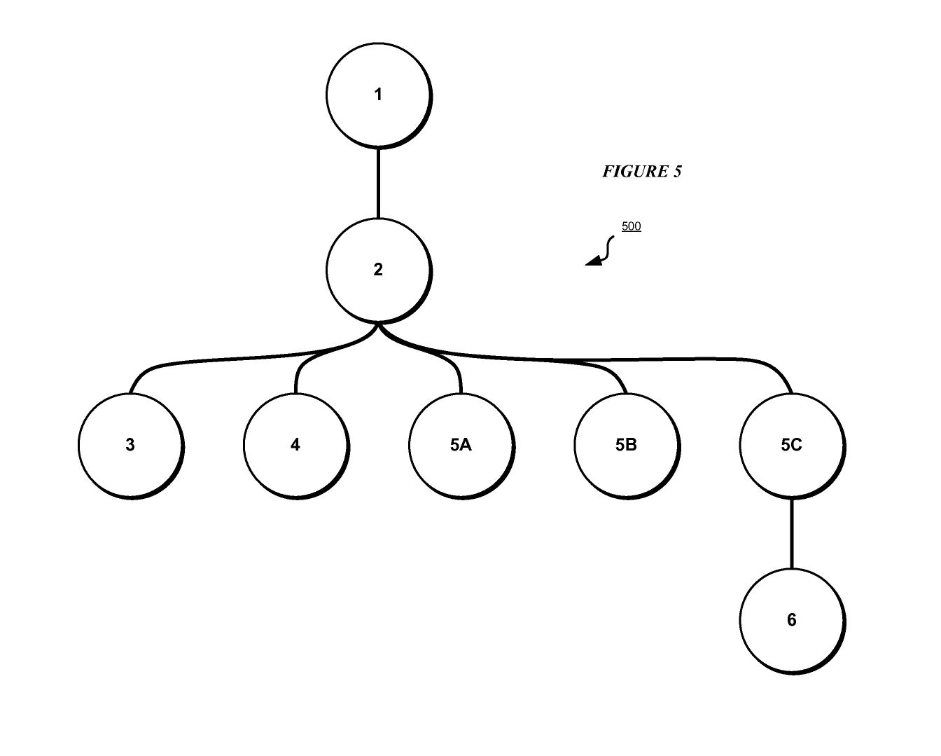

With reference to FIG. 5, this figure depicts a logical arrangement of responsibilities in a dynamic project or team in the organization in accordance with an illustrative embodiment. Logical arrangement 500 shows the delegations made in FIG. 3. The deliverables of the delegated responsibilities flow in the direction opposite of the delegations of FIG. 3, i.e., from employee 6 to employee 5c; from employee 5c to employee 2; from employee 5b to employee 2; from employee 5a to employee 2; from employee 4 to employee 2; from employee 3 to employee 2; and from employee 2 to employee 1.

There will be electronic communications of the delegations, and of the deliveries with respect to this dynamic team operations. Electronic communications are possible between nodes that are not shown to be connected in this figure. For example, employee 6 may send a message asking a question to employee 2, or employees 3 and 5c may exchange messages to resolve a problem in accomplishing a certain task. A collection of the electronic communications resulting from the depicted and not-depicted node connections is analyzed to form the relationship entries.

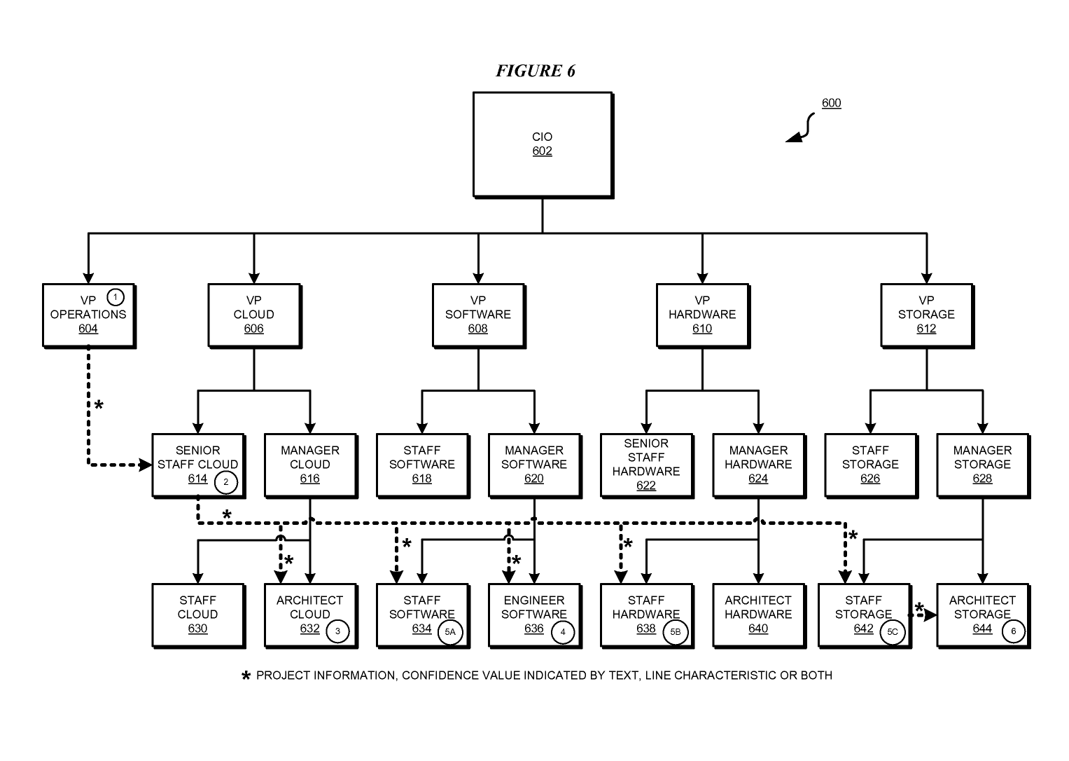

With reference to FIG. 6, this figure depicts an integrated organization hierarchy in accordance with an illustrative embodiment. Integrated organization hierarchy 600 is an example of integrated organization hierarchy 113 in FIG. 1.

Nodes 602, 604, 606, 608, 610, 612, 614, 616, 618, 620, 622, 624, 626, 628, 630, 632, 634, 636, 638, 640, 642, and 644 and the solid lines are a manner of visually depicting a traditional organization hierarchy, such as organization hierarchy 111 in FIG. 1. Organization hierarchy 400 is a part of such a traditional organization hierarchy. As was the case with organization hierarchy 400 in FIG. 4, nodes 602-644 and the solid interconnects therebetween, as in the traditional organization hierarchy, are insufficient to depict the dynamic participations of employee 1 (602), employee 2 (614), employee 3 (632), employee 4 (636), employee 5a (634), employee 5b (638), employee 5c (642), and employee 6 (644).

An embodiment, such as an embodiment implemented in application 105 in FIG. 1, combines the relationship entries corresponding to the depicted and not-depicted node connections in FIG. 5 with the traditional organization hierarchy in FIG. 6 to result in integrated organization hierarchy 600. Particularly, the dotted lines marked with “*” are added to the traditional organization hierarchy to modify the visual appearance of the tradition organization hierarchy to visually appear as integrated organization hierarchy 600.

The dotted lines show that within the traditional organization hierarchy, roles or names (as the case may be) 604, 614, 632, 634, 636, 638, 642, and 644 are related to one another in some engagement. Each of the links depicted by the dotted lines can have text labels, color, weight, pattern, or some combination of these and other possible characteristics, to provide additional information about the project or one or more confidence values described herein, if the application has extracted such information from some electronic communications.

Integrated organization hierarchy 600 is a simplified view of a simplified traditional organization hierarchy enhanced with one set of the dynamic relationships between some roles or names. It is not uncommon for a traditional organization hierarchy to include hundreds or thousands of node, depending upon the size of the organization and the granularity of the traditional organization hierarchy. Within the scope of the illustrative embodiments, an integrated organization hierarchy resulting from such large traditional organization hierarchies can include numerous sets of dynamic relationships represented by lines and other visual artifacts of various characteristics.

Furthermore, an integrated organization hierarchy may have one role or name participating in numerous dynamic projects or teams. Thus, within the scope of the illustrative embodiments, an integrated organization hierarchy according to the illustrative embodiments can produce a complex and comprehensive view of the dynamic involvements of the participants from all or a part of an organization.

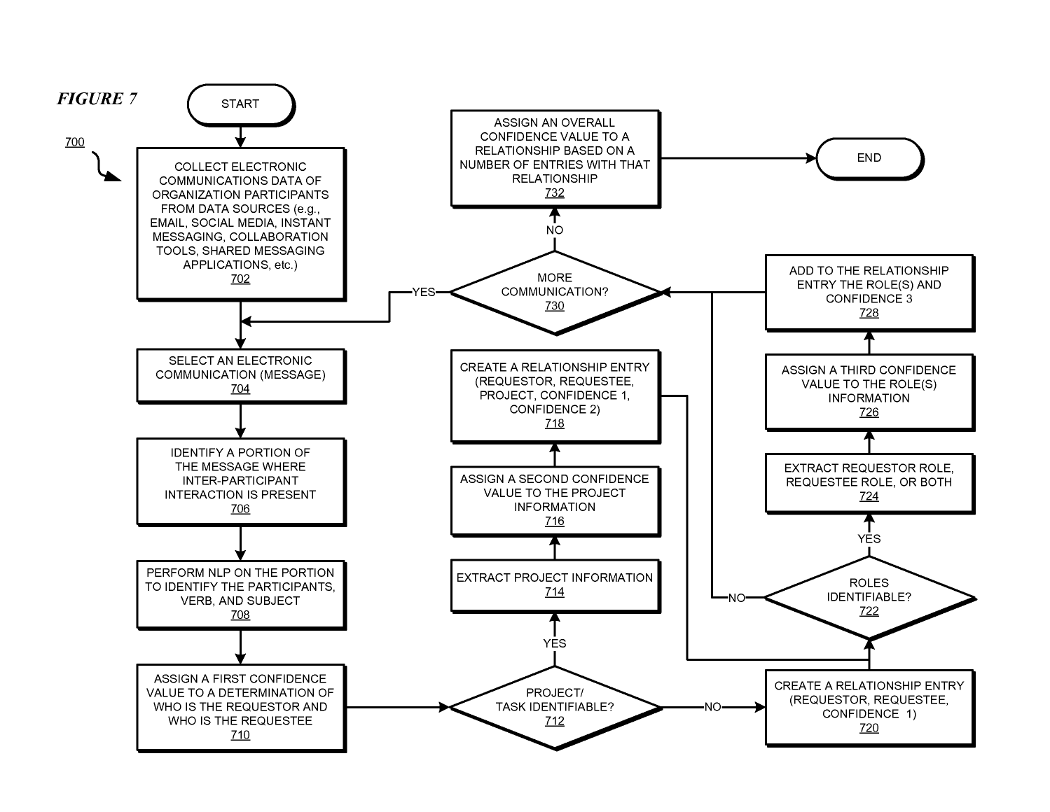

With reference to FIG. 7, this figure depicts a flowchart of an example process for integrating dynamic interpersonal relationships in an organization hierarchy in accordance with an illustrative embodiment. Process 700 can be implemented in application 105 in FIG. 1.

The application collects, from a set of data sources, electronic communications data of a set of participants in an organization (block 702). Such data sources include but are not limited to some combination of an email server, a social media server, an instant messaging platform, a collaboration tool, and a shared messaging application.

The application selects an electronic communication, i.e., a message, from the collected data (block 704). The application identifies one or more portions of the message where a content indicative of inter-participant interaction is present (block 706). The application analyzes the one or more portions using NLP to identify the participants, the verb, and a subject (block 708). The application assigns a first confidence value to a determination from the analysis, where the determination identifies one or more requestor participant and one or more requestee participant in the identified participants (block 710).

The application determines whether project or task information is available in some portion of the selected message and can be extracted via NLP (block 712). If the project or task information is available and can be extracted (“Yes” path of block 712), the application extracts the project information from the message (block 714). The application assigns a second confidence value to the information extracted in block 714 (block 716).

Some example manners of assigning confidence values are described herein. These examples of manners of computing and assigning confidence values are not intended to be limiting. From this disclosure, those of ordinary skill in the art will be able to conceive many other ways in which confidence values can be computed and assigned, and the same are contemplated within the scope of the illustrative embodiments.

The application creates a relationship entry in a repository, the relationship entry identifying the requestor, the requestee, the project information, the first confidence value, and the second confidence value (block 718). The application then proceeds to block 722.

If the project or task information is not identifiable, not available, or cannot be extracted (“No” path of block 712), the application extracts the project information from the message (block 714). The application creates a relationship entry in the repository, the relationship entry identifying the requestor, the requestee, and the first confidence value (block 718).

The application determines if participant roles (or names, as they may be used in the traditional organization hierarchy of the org) are identifiable in the message block 722). If participant roles or names are not identifiable in the message (“No” path of block 722), the application proceeds to block 730. If participant roles or names are identifiable in the message, such as by being available and extractable (“Yes” path of block 722), the application extracts the requestor role (or name), requestee role (or name), or both, as may be available in the message (block 724).

The application assigns a third confidence value to the roles or names information extracted in block 724 (block 726). The application adds to the relationship entry created in block 718 or 720, the roles or names extracted in block 724, and the third confidence value assigned in block 726 (block 728).

The application determines if more electronic communication remains in the data collected in block 702 (block 730). If more electronic communications remain (“Yes” path of block 730), the application returns to block 704 to select another message for similar processing.

If no more electronic communications remain (“No” path of block 730), the application assigns an overall confidence value to a relationship based on a number of entries present in the repository with that relationship (block 732). For example, the same requestor and requestee may appear in several electronic communications, and therefore in several relationship entries in the repository. The more a relationship appears in the repository, the more likely it is that the relationship has been identified correctly, to wit, the confidence in that relationship's existence is greater than a threshold. The application assigns the overall confidence value to each relationship entry which includes that relationship. The application ends process 700 thereafter.

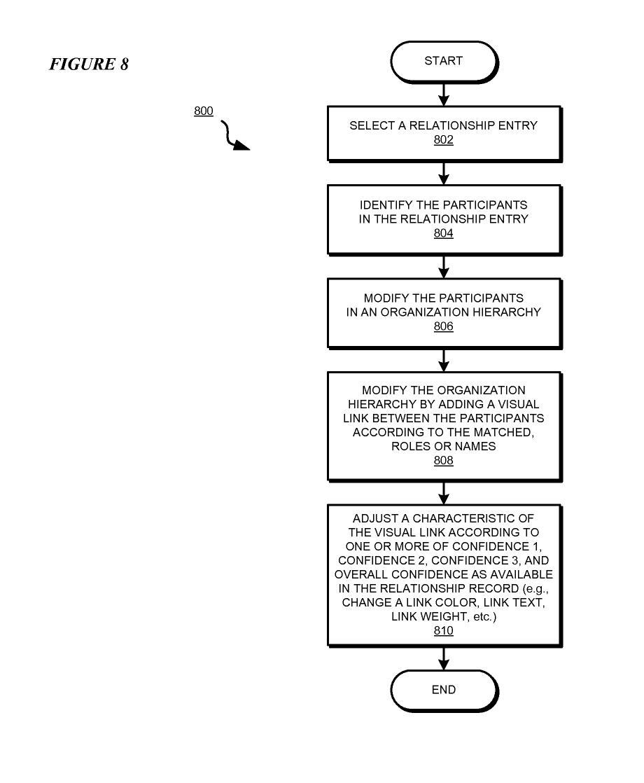

With reference to FIG. 8, this figure depicts a flowchart of an example process of integrating dynamic interpersonal relationships in an organization hierarchy in accordance with an illustrative embodiment. Process 800 can be implemented in application 105 in FIG. 1.

The application selects a relationship entry from a repository, such as a relationship entry created in blocks 718, 720, or 732 in FIG. 7 (block 802). The application identifies the participants in the relationship entry (block 804). The application matches the identified participants into a traditional organization hierarchy, such as by matching the identified participants' roles or names with roles or names present in the traditional organization hierarchy (block 806).

The application modifies the traditional organization hierarchy by adding a visual link, such as a line, between the identified participants using the matching roles or names in the traditional organization hierarchy (block 808). The application adjusts a characteristic of the visual link according to one or more of the first confidence value, the second confidence value, the third confidence value, the overall confidence value, the project information, or some combination thereof, as may be available in the relationship entry (block 810). The adjustments can take any of the forms described herein or other suitable forms for a similar purpose. The application ends process 800 thereafter.

Thus, a computer implemented method, system or apparatus, and computer program product are provided in the illustrative embodiments for integrating dynamic interpersonal relationships in an organization hierarchy. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining resource utilization in an organization, the method comprising:
identifying, in a human-readable content of a message, a portion describing an interaction between a first participant and a second participant;
analyzing, using a processor and a memory for Natural Language Processing (NLP), the portion to extract a verb and a subject corresponding to the interaction;
characterizing, using the verb, the first participant as a requestor of a participation related to the subject and the second participant as a requestee of the participation related to the subject;
assigning a first confidence value to a requestor-requestee relationship between the first participant and the second participant;
adding a relationship entry in a repository, the relationship entry comprising an identifier of the requestor, an identifier of the requestee, and the first confidence value;
modifying a visual representation of an organization hierarchy by adding, in the visual representation, a link between the identifier of the requestor and the identifier of the requestee, forming an integrated organization hierarchy; and
computing, using a set of visual links associated with the requestee in the integrated organization hierarchy, a utilization of the requestee.

2. The method of claim 1, further comprising:
adjusting, according to the first confidence value, a characteristic of the visual link, wherein the characteristic is one of a text label, a color, a weight, and a pattern of the visual link.

3. The method of claim 1, further comprising:
extracting, from the message, a project information, wherein the subject refers to a deliverable in a project corresponding to the project information;
assigning a second confidence value to the project information; and
adding the project information and the second confidence value to the relationship entry.

4. The method of claim 1, further comprising:
extracting, in the analysis, the identifier of the requestor, wherein the identifier is a role occupied by the requestor in the organization; and
matching the role with a second role in the organization hierarchy, wherein the modifying is responsive to the matching.

5. The method of claim 1, further comprising:
extracting, in the analysis, the identifier of the requestor, wherein the identifier is a name of the requestor; and
matching the name with a second name in the organization hierarchy, wherein the modifying is responsive to the matching.

6. The method of claim 1, further comprising:
selecting, from a set of relationship entries in the repository, a subset of relationship entries, wherein each relationship entry in the subset includes the requestor-requestee relationship, the subset including the relationship entry;
assigning, to each relationship entry in the subset, an overall confidence value, the overall confidence value corresponding to an accuracy of the requestor-requestee relationship between the first participant and the second participant, wherein a characteristic of the visual link is proportional to the overall confidence value.

7. The method of claim 1, wherein the portion is other than a second portion of the message where a sender of the message and a receiver of the message are identified.

8. The method of claim 7, wherein the requestor is distinct from the sender of the message and the requestee is distinct from the receiver of the message.

9. The method of claim 1, where the subject is distinct from a content in a subject-line portion of the message.

10. The method of claim 1, further comprising:
collecting, from a set of data sources, a set of electronic communications, wherein the message is a member of the set of electronic communications, wherein the set of data sources includes the social media source and an email server, the social media source and the email server being configured in a data network operated by the organization.

11. The method of claim 1, wherein the method is embodied in a computer program product comprising one or more computer-readable storage devices and computer-readable program instructions which are stored on the one or more computer-readable tangible storage devices and executed by one or more processors.

12. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

13. A computer program product for determining resource utilization in an organization, the computer program product comprising one or more computer-readable storage devices, and program instructions stored on at least one of the one or more storage devices, the stored program instructions comprising:
program instructions to identify, in a human-readable content of a message, a portion describing an interaction between a first participant and a second participant;
program instructions to analyze, using a processor and a memory for Natural Language Processing (NLP), the portion to extract a verb and a subject corresponding to the interaction;
program instructions to characterize, using the verb, the first participant as a requestor of a participation related to the subject and the second participant as a requestee of the participation related to the subject;
program instructions to assign a first confidence value to a requestor-requestee relationship between the first participant and the second participant;
program instructions to add a relationship entry in a repository, the relationship entry comprising an identifier of the requestor, an identifier of the requestee, and the first confidence value;
program instructions to modify a visual representation of an organization hierarchy by adding, in the visual representation, a link between the identifier of the requestor and the identifier of the requestee, forming an integrated organization hierarchy; and
program instructions to compute, using a set of visual links associated with the requestee in the integrated organization hierarchy, a utilization of the requestee.

14. The computer program product of claim 13, further comprising:
program instructions to adjust, according to the first confidence value, a characteristic of the visual link, wherein the characteristic is one of a text label, a color, a weight, and a pattern of the visual link.

15. The computer program product of claim 13, further comprising:
program instructions to extract, from the message, a project information, wherein the subject refers to a deliverable in a project corresponding to the project information;
program instructions to assign a second confidence value to the project information; and
program instructions to add the project information and the second confidence value to the relationship entry.

16. The computer program product of claim 13, further comprising:
program instructions to extract, in the analysis, the identifier of the requestor, wherein the identifier is a role occupied by the requestor in the organization; and
program instructions to match the role with a second role in the organization hierarchy, wherein the modifying is responsive to the matching.

17. The computer program product of claim 13, further comprising:
program instructions to extract, in the analysis, the identifier of the requestor, wherein the identifier is a name of the requestor; and
program instructions to match the name with a second name in the organization hierarchy, wherein the modifying is responsive to the matching.

18. The computer program product of claim 13, further comprising:
program instructions to select, from a set of relationship entries in the repository, a subset of relationship entries, wherein each relationship entry in the subset includes the requestor-requestee relationship, the subset including the relationship entry;
program instructions to assign, to each relationship entry in the subset, an overall confidence value, the overall confidence value corresponding to an accuracy of the requestor-requestee relationship between the first participant and the second participant, wherein a characteristic of the visual link is proportional to the overall confidence value.

19. The computer program product of claim 13, wherein the portion is other than a second portion of the message where a sender of the message and a receiver of the message are identified.

20. A computer system for determining resource utilization in an organization, the computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to identify, in a human-readable content of a message, a portion describing an interaction between a first participant and a second participant;
program instructions to analyze, using a processor and a memory for Natural Language Processing (NLP), the portion to extract a verb and a subject corresponding to the interaction;
program instructions to characterize, using the verb, the first participant as a requestor of a participation related to the subject and the second participant as a requestee of the participation related to the subject;
program instructions to assign a first confidence value to a requestor-requestee relationship between the first participant and the second participant;
program instructions to add a relationship entry in a repository, the relationship entry comprising an identifier of the requestor, an identifier of the requestee, and the first confidence value;
program instructions to modify a visual representation of an organization hierarchy by adding, in the visual representation, a link between the identifier of the requestor and the identifier of the requestee, forming an integrated organization hierarchy; and
program instructions to compute, using a set of visual links associated with the requestee in the integrated organization hierarchy, a utilization of the requestee.
